(19) United States
(12) Patent Application Publication
(10) Pub. No.: US 2015/0204602 A1
(43) Pub. Date: Jul. 23, 2015

(54) HEAT EXCHANGE UNIT FOR SELF-COOLING BEVERAGE CONTAINER

(71) Applicant: JOSEPH COMPANY INTERNATIONAL, INC., Irvine, CA (US)

(72) Inventor: Mark Sillince, Rustington West Sussex (GB)

(73) Assignee: JOSEPH COMPANY INTERNATIONAL, INC., Irvine, CA (US)

(21) Appl. No.: 14/425,094

(22) PCT Filed: Oct. 11, 2013
(86) PCT No.: PCT/US13/64687

§ 371 Date: Mar. 2, 2015

Related U.S. Application Data
(60) Provisional application No. 61/714,128, filed on Oct. 15, 2012.

(51) Int. Cl. F25D 31/00; F17C 5/06; F25B 17/08

(52) U.S. Cl. CPC F25D 31/007; F25B 17/08; F17C 5/06

(57) ABSTRACT

An apparatus and method which includes placing an HEU containing compacted carbon particles within a cavity defined within a fixture and connecting a source of carbon dioxide gas under pressure to the fixture and to the HEU for flooding the carbon particles within the HEU with the carbon dioxide gas under pressure for a predetermined period of time sufficient to totally purge the trapped air contained within the HEU and then placing a cover or cap on the HEU to retain the residual head of carbon dioxide gas on the carbon particles until the gassing cycle is accomplished.

### BACKGROUND OF THE INVENTION

1. Field of the Invention

This invention relates generally to beverage containers which include a heat exchange unit (HEU) housed therein for self-cooling a beverage and more specifically is directed to a method and apparatus for enhancing the adsorption of carbon dioxide on carbon in the HEU.

2. Description of Prior Art

Self-cooling beverage containers which include a heat exchange unit are well known in the prior art and various types of heat exchange units have been developed to accomplish the desired self-cooling. Various types of refrigerants have been disclosed in the prior art for accomplishing the cooling utilizing the heat exchange units. Typical of such devices are those disclosed in U.S. Pat. Nos. 2,460,765; 3,373,581; 3,636,726; 3,726,106; 4,584,848; 4,656,838; 4,784,678; 5,214,933; 5,285,812; 5,325,680; 5,331,817; 5,394,703; 5,606,866; 5,692,381; 5,692,391; 5,655,384; 6,102,108; 6,105,384; and 6,125,649.

The self-cooling devices as utilized in the prior art exemplified by the above-identified patents are generally unsatisfactory for various reasons among which are that many of the refrigerants used were deleterious to the environment.

As a result of some of the unsatisfactory aspects of the prior devices, there has been developed a heat exchange unit which utilizes activated carbon which adsorbs carbon dioxide under pressure thereon to function as the refrigerant. Such a device is illustrated in FIG. 1 to which reference is hereby made.

Referring now particularly to FIG. 1, there is shown a prior art beverage self-cooling container (112) which includes an HEU (120) having internally thereof an adsorbent (138) which in the preferred embodiment is an activated carbon which receives carbon dioxide under pressure which is inserted through the valve mechanism (124) to enter into the internal part of the HEU through the opening (128) to be adsorbed by the carbon. The valve (124) is held in place by flange (122) which is crimped to the necked in top portion (132) of the HEU (120). A protective cover 150 is placed over the activating stem (130) of the valve (124) to protect it from inadvertent activation. When the activating stem (130) is depressed, the carbon dioxide is desorbed from the carbon to cool the beverage (114). The top (116) of the container (112) includes the well known typical pull tab (not shown). If the pressurized carbon dioxide contained internally of the HEU (120) over pressurizes, the necked in portion (134) of the HEU (120) will move outwardly causing a release of the valve rendering the device unusable.

As a result of the failures of such prior art devices there has been developed a HEU which is constructed of a lower metal shell having a closed bottom and an open top, which receives a compacted adsorbent material, typically activated carbon, disposed internally thereof. A metal top section having an open upper end is fitted over the open end of the shell and is secured to the outer surface of the shell by a metal to metal adhesive, thus bonding the top section to the shell. Such a structure is shown in FIGS. 2 through 5 to which reference is hereby made.

Referring now more particularly to FIG. 2, there is illustrated a HEU (200) which has a metal shell (202) and a metal top section (204) which is secured to the top of the shell (202) as will be described in more detail below.

The upper portion of the top section (204) of the HEU terminates in an opening (206) defined by a solid curl (208). The solid curl (208) receives a valve mechanism of the type generally above described in the prior art which is carried by a typical mounting member having a pedestal within which there is sealingly secured the appropriate dispensing valve. The valve includes the typical stem extending through the central opening in the pedestal and a safety device that will open under excess pressure. The mounting member is inserted into the opening (206) at the top section and the outer periphery thereof and is affixed to the curl (208) by way of a crimping operation as is well known to those skilled in the art. The crimping operation not only secures the valve assembly to the HEU (200) but in addition closes and seals the open upper end of the HEU and the can to which it is affixed typically through the use of a gasket (not shown). A more detailed explanation of the valve and the crimping operation may be found in U.S. Pat. No. 6,105,384 which is incorporated herein by this reference.

The heat exchange unit (200) for the present invention is an adsorbent/desorbent mechanism preferably utilizing compacted activated carbon which is capable of adsorbing, under pressure, a significant quantity of carbon dioxide gas for later release. The carbon dioxide adsorbed on the adsorbent, preferably activated carbon particles, when released to atmospheric pressure will experience a significant drop in temperature thereby chilling the beverage which comes into contact with the outer surface of the heat exchange unit (200). A more detailed explanation of the carbon-carbon dioxide adsorbent refrigeration system is contained in U.S. Pat. No. 7,185,511 and incorporated herein by reference. Therefore a further and more detailed explanation of the carbon-carbon dioxide refrigerant system will not be provided herein.

As shown in FIG. 3, the metal shell (202) has a closed bottom (203) and an open top (205) which terminates in a rim (207) and is preferably formed from impact extruded aluminum. A carbon member or plug (210) which is a highly compressed body preferably of activated carbon particles and a graphite material with a binder is preformed and is inserted and received internally of the HEU shell and extends substantially upwardly toward and adjacent the upper perimeter (212) of the HEU shell. Through the use of the open ended shell and the preformed plug (210) of carbon material, the maximum amount of adsorbent material can be contained within the HEU. Once the valve, as above described, is secured in place on the top section (204), a pressurized medium such as carbon dioxide is inserted through the valve into the interior of the HEU (200) and is adsorbed by the compressed carbon particles contained within the carbon plug (210). Upon activation of the valve, the carbon dioxide gas is desorbed from the carbon cooling the food or beverage in the container in which the HEU (200) is housed.

As is illustrated in FIG. 4, the top section (204) of the HEU (200) is shaped so that a skirt (216) thereof fits over the outer surface (218) of the HEU shell (202). The skirt (216) of the top section (204) includes an inner surface (214). The inner surface (214) of the top section (204), receives an appropriate metal to metal adhesive bonding material to permanently secure the top section (204) of the HEU (200) to the HEU shell (202). Various food grade adhesives may be utilized so long as they permanently bond the top (214) to the shell (202) of the HEU (200) and form a secure seal to retain the pressurized carbon dioxide within the HEU.

The top section (204) may be machined from a blank of appropriate metal such as stainless steel. Preferably, the top section (204) may be die cast from zinc or aluminum. Whether the top section (204) is machined or die cast, or formed by other methods such as eyelet stamping or forming or spinning, it has the required strength to withstand the pressures generated by the pressurized carbon dioxide and even under high temperature conditions will not fail.

As is shown more clearly in FIG. 5, the top section (204) is formed to provide a shoulder or stop (226) which is disposed on the internal surface (214) of the top section (204). The shoulder (226) is disposed to mate with the rim (207) of the shell (202) of the HEU (200). After the carbon plug (210) has been positioned internally of the shell (202), the top section (204) has the appropriate adhesive applied internally thereof and is then slipped in place over the outer surface (218) of the shell (202) until the rim (207) thereof engages the shoulder (226) whereupon the top section (204) is now in place. Upon setting of the adhesive, the top section (204) is then permanently positioned and held in place and bonded to the shell (202) so that it cannot be removed.

The open upper portion (208) of the top section (204) is formed to provide a solid curl (232) which receives the crimped flange of the outer periphery of the mounting member of the valve as above described. The top section (204) of the HEU (202) is formed, preferably from die cast zinc or aluminum it will be sufficiently strong so as not to crush or move under the pressure which may be generated by the cooling medium such as the carbon dioxide gas, that is adsorbed by the carbon plug (210).

Through the utilization of a construction such as that illustrated and described above, the maximum amount of highly compressed carbon particles can be received within the HEU shell to maximize the amount of carbon dioxide which can be adsorbed by the HEU. As is well known and described in the prior art, when the valve through which the carbon dioxide is inserted into the carbon plug (210) is activated, the adsorbed carbon dioxide then desorbs from the carbon particles and exits the HEU and in doing so removes heat from the food or beverage surrounding the external surface (218) of the HEU thereby cooling the food or beverage to the desired amount to make it more palatable. As is described in U.S. Pat. No. 6,105,384, which is incorporated by reference, a protective food grade coating may be applied to the entire external surface of the HEU to preclude any contamination of the food or beverage surrounding the HEU or the possible alteration of the taste thereof. The coating may be a food grade epoxy lacquer having a thickness of between 4 and 10 microns.

It has been discovered that it requires a significant period of time to adsorb the desired amount of C02 onto the carbon particles. What is needed is an apparatus and method to obtain faster and more complete adsorption of the C02 onto the compacted carbon, within a shorter period of time.

### SUMMARY OF THE INVENTION

A method comprising injecting carbon dioxide under pressure into a HEU including a bottom section containing compacted carbon particles and maintaining the pressure for a time sufficient to remove residual air trapped in the pores of the compacted carbon and replace it with carbon dioxide gas adsorbed onto the carbon particles.

An apparatus including a fixture for receiving the completed heat exchange unit source of carbon dioxide gas under pressure, a valve to control application of the gas to the HEU, a timer for maintaining gas under pressure in the HEU for a time sufficient to replace residual air therein with carbon dioxide gas.

### BRIEF DESCRIPTION OF THE DRAWINGS

FIG. 1 through 5 illustrate prior art;

FIG. 6 is a block diagram of an apparatus constructed in accordance with the principles of the present invention;

FIG. 7 is a perspective view of an apparatus constructed in accordance with the principles of the present invention.

FIG. 8 is a top plan view thereof;

FIG. 9 is a front plan view thereof;

FIG. 10 is a side plan view thereof;

FIG. 11 is a cross-sectional view taken about the lines 10-10 of FIG. 9 illustrating the HEU seated within the apparatus;

FIG. 12 is a schematic view illustrating an apparatus including plurality of cavities for receiving plurality HEU's to be treated simultaneously; and

FIG. 13 is a cross-sectional view of a cap to be placed on the HEU after the injected C02 has been released.

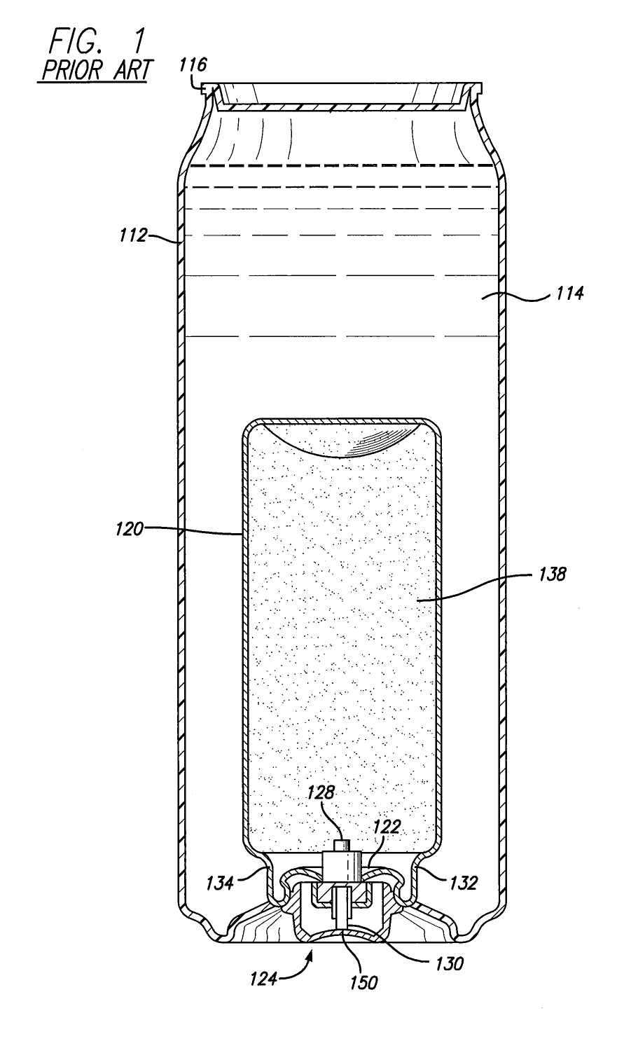

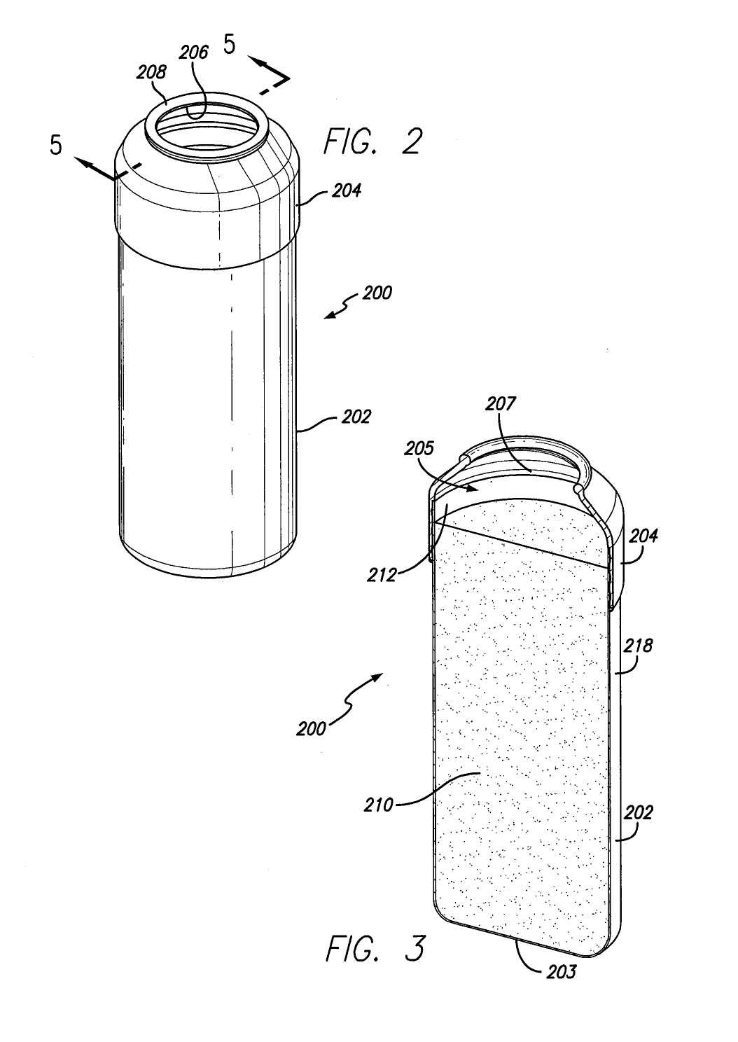

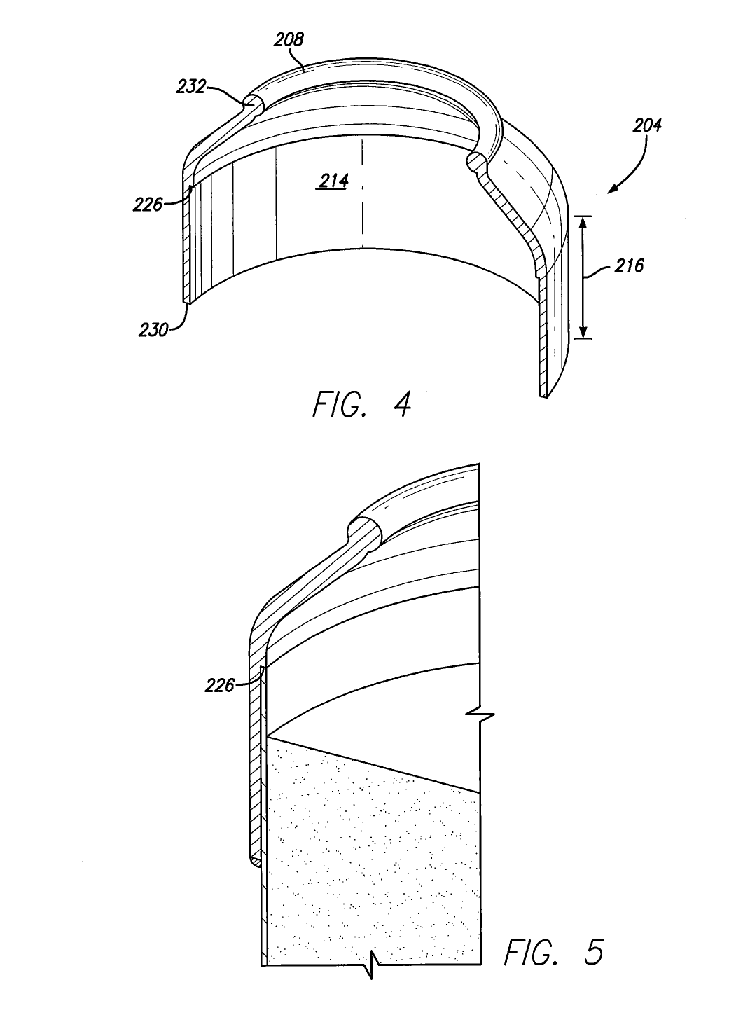

### DETAILED DESCRIPTION

When the carbon dioxide gas under pressure is inserted into the HEU in order to have the gas adsorbed onto the carbon particles, heat is generated and must be dissipated. As the heat is generated, it limits the amount of carbon dioxide gas that can be adsorbed onto the carbon particles. As a result, the manufacturing process of inserting the carbon dioxide into the HEU must be stopped or the HEU must be subjected to a cooling cycle so that an additional period of injecting the carbon dioxide gas into the HEU can be accomplished to have the required amount of carbon dioxide gas adsorbed so that the HEU can properly function to chill the food or beverage surrounding the HEU when the carbon dioxide gas is desorbed from the carbon particles. It has been found now that one of the difficulties encountered is that the initial application of the carbon dioxide gas into the HEU must remove the trapped air that is contained within the carbon particles. As a result and in accordance with the principles of the present invention, it has been found that by initially applying carbon dioxide gas to the HEU can shorten the period of time required to apply the required amount of carbon dioxide gas during the manufacturing process. To accomplish this, the HEU is positioned within a fixture which may be connected to a source of carbon dioxide gas under pressure in such a manner that the carbon dioxide gas can be inserted into the HEU prior to the normal manufacturing process and then maintained for a sufficient period of time to replace the air which is trapped within the carbon particles. Such a process will then provide a situation where the maximum amount of carbon dioxide gas can be adsorbed by the carbon particles in the HEU during the gassing stage of manufacture in a shorter period of time than has been the case in the prior art thereby shortening the manufacturing process time.

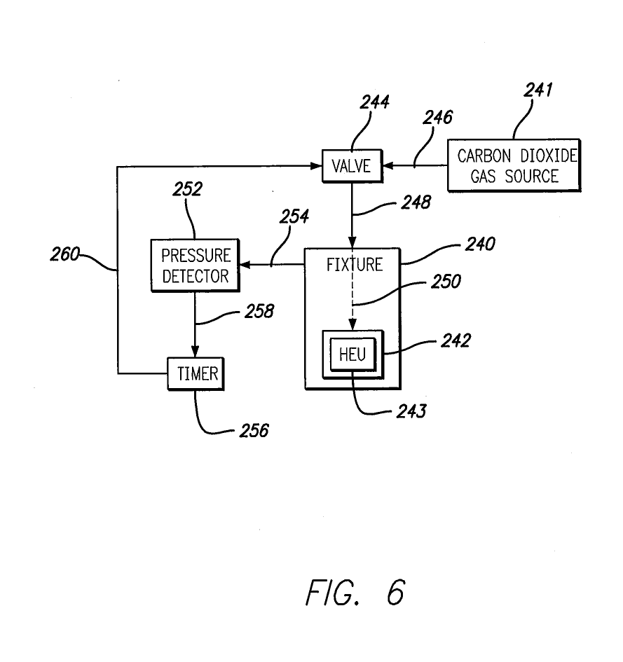

In accordance with the present invention reference is now made specifically to FIG. 6 which is a block diagram illustrating the method and the apparatus for replacing the trapped air in the HEU with carbon dioxide gas in accordance with the principles of the present invention. As is shown in FIG. 6, there is provided a fixture 240 which defines a cavity 242 within which there is positioned an HEU 243. The HEU has contained therein compacted carbon particles as above described. A source of carbon dioxide gas under pressure 241 is connected to a valve 244 by way of a conduit 246. The valve in turn is connected to the fixture 240 by a conduit 248 which is positioned internally of the fixture 240 and is connected, as shown by the conduit 250, to the HEU 243. A pressure detector 252 is connected to the fixture 240 by the conduit 254 to sense the fact that carbon dioxide gas under pressure has been initially applied to the HEU 243. The pressure detector in turn is connected to a timer mechanism 256 by way of a conduit 258. The timer mechanism 256 is adapted to generate a signal after a predetermined period of time which is applied by the lead 260 to the valve 244. The timer is adapted to maintain the carbon dioxide gas under pressure applied to the HEU 243 for a period of time sufficient to completely replace all of the air trapped within the carbon particles in the HEU by the carbon dioxide gas. Once this period of time has passed, the timer is adapted to provide a signal as above referred to which, when it is applied to the valve 244, will automatically close the valve, thus removing the source of carbon dioxide gas 241 from the fixture 240. When such is done, a closure such as a cap is applied to the HEU to retain the carbon dioxide gas which has been injected into it to replace the air so that it will be retained until such a time as the HEU with the carbon dioxide residual gas contained therein is then processed to fill the HEU with the required amount of carbon dioxide gas to accomplish the required adsorption thereof to in turn provide a desired cooling of the food or beverage which surrounds the HEU which is secured within the container as above referred to.

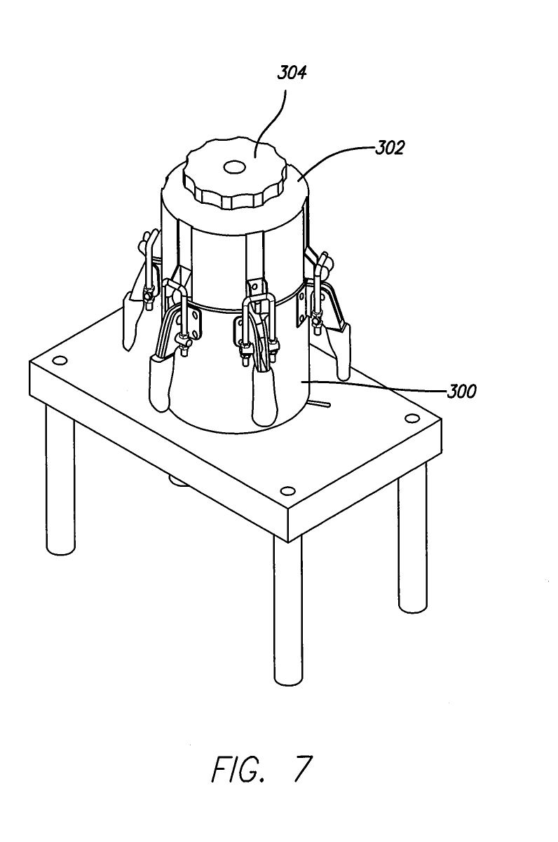

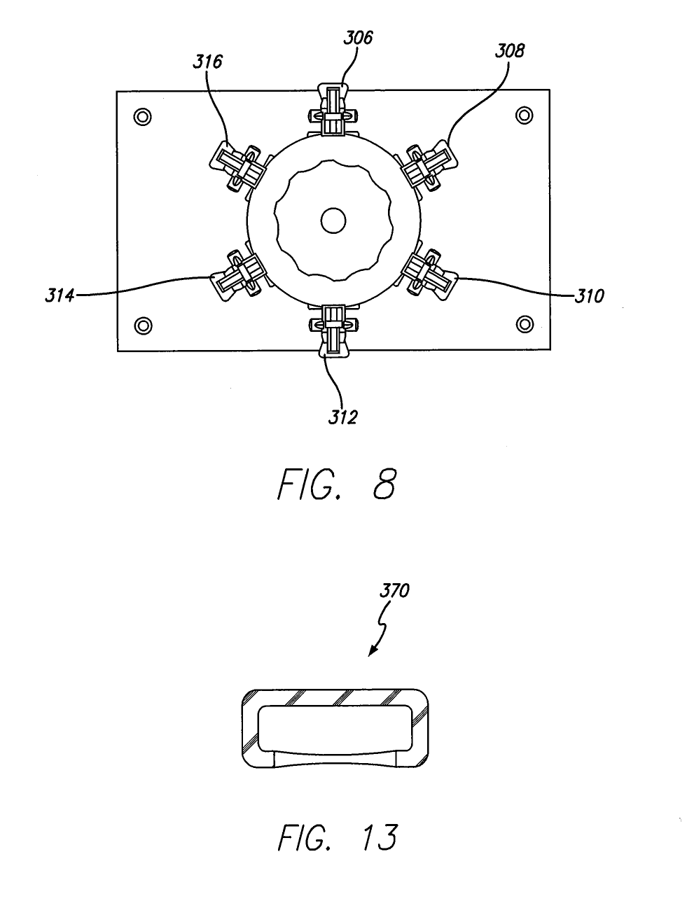

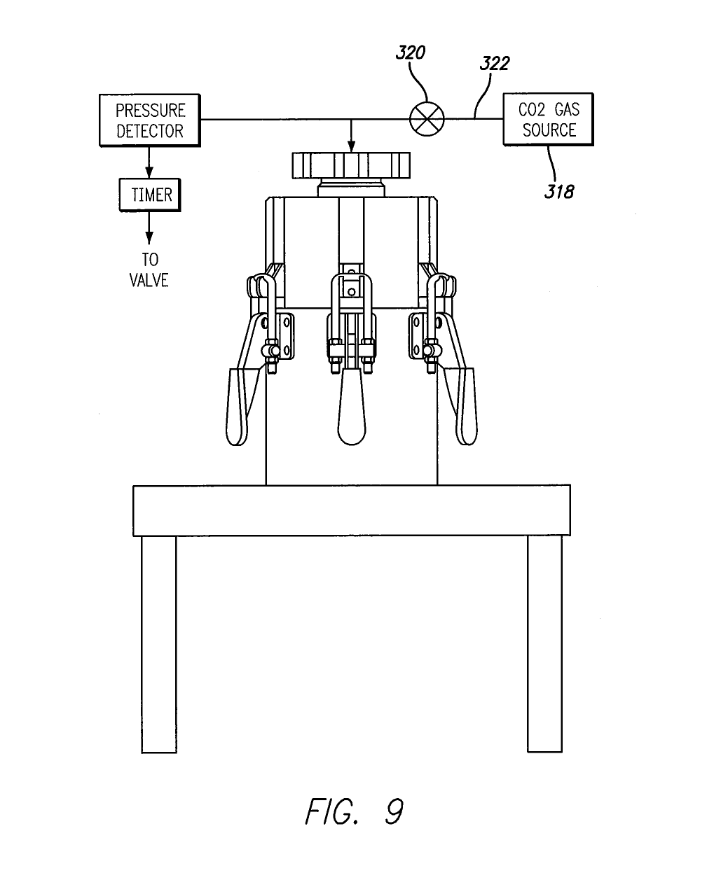

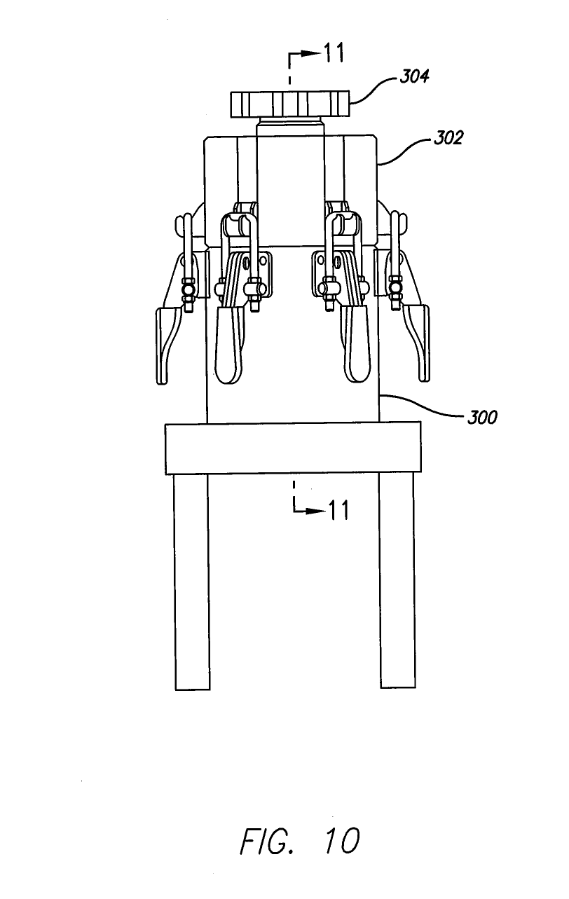

Referring now more specifically to FIGS. 7-10, there is illustrated a single head heat exchange unit (HEU) fixture designed to accept a HEU for the purpose of flooding it with C02 under pressure to replace the air trapped within the carbon particles therein. As is illustrated the fixture includes a bottom block (300) and top block (302), a gas inlet adaptor (304) is inserted into the top block (302), a plurality of toggle clamps (306)-(316) are utilized to secure and clamp the top block (302) to the bottom block (300) to seal the two together so that a pressurized carbon dioxide gas from a source (318) thereof can be inserted through the gas inlet adaptor (304) to the HEU. An appropriate valve mechanism (320) is included in the conduit (322) which conducts the CO2 gas from the source (318) into the fixture

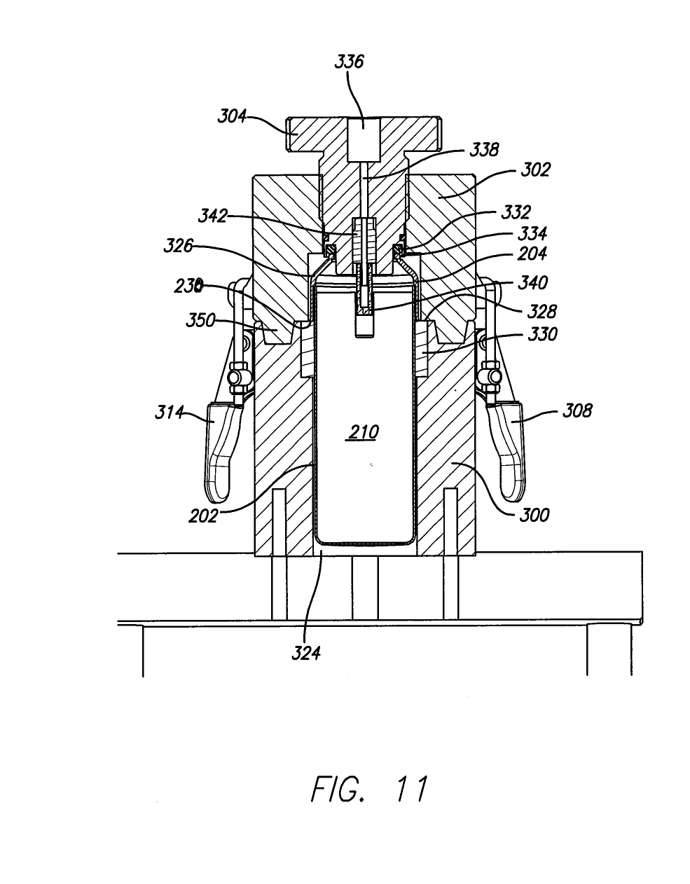

Referring now more particularly to FIG. 11, the apparatus as shown in FIGS. 7 through 10 is illustrated in partial cross-section and includes a HEU assembly 326 inserted into a cavity (324) defined in the bottom block (300). The HEU assembly (326) includes the metal shell (202) and the top section (204). The gas inlet adaptor (304) carries an HEU pressure seal (332) within a groove (334) formed therein. The adaptor (304) defines a gas inlet (336) and a gas channel (338) which carries the C02 under pressure into the internal portion of the HEU which contains the compacted activated carbon particles (210). A dust filter (340) is carried internally of the filter carrier (342) and is used to collect any of the carbon particles which may be disturbed by the high pressure CO2 which is inserted into the interior portion of the HEU.

The operation of the apparatus is as follows: the toggle clamps (306) through (316) are unlatched and the top block (302) is removed from the fixture. The HEU assembly (326) is then inserted into the cavity (324) formed in the bottom block (300) until the rim (230) of the top section is seated on the steal support ring (330). The top block (302) is then placed over the HEU and aligned into the alignment cones (350) formed between the bottom block (300) and the top block (302). Thereafter, all six of the toggle clamps are closed and locked into place to be sure that the high pressure seal (332) is seated against the top of the HEU assembly (326). It should be understood that other means may be utilized to sealably secure the top and bottom blocks together such as a threaded ring, having engaging threads between the top and bottom block or the like. The valve (320) is then opened to allow the CO2 gas under pressure to enter the interior of the HEU assembly (326). The pressure of the CO2 gas is between approximately 10 and 50 bars.

The system control contains a pressure detector 252 so that when the C02 pressure is detected a signal is provided which initiates a timer 256, which maintains the pressure in the HEU assembly (326) at a predetermined level for a predetermined period of time.

The amount of pressure and the time selected to maintain the pressure is determined by how long it will take to purge the compacted carbon of substantially all residual air particles. It has been found that by purging the residual air particles and replacing them with the C02 a larger amount of C02 can be adsorbed onto the compacted carbon in a shorter time during the HEU gassing cycle. What occurs is that when the C02 is released there is a residual head of approximately 10 grams of C02 left on the carbon. This then provides a 10 gram head start on the gassing cycle.

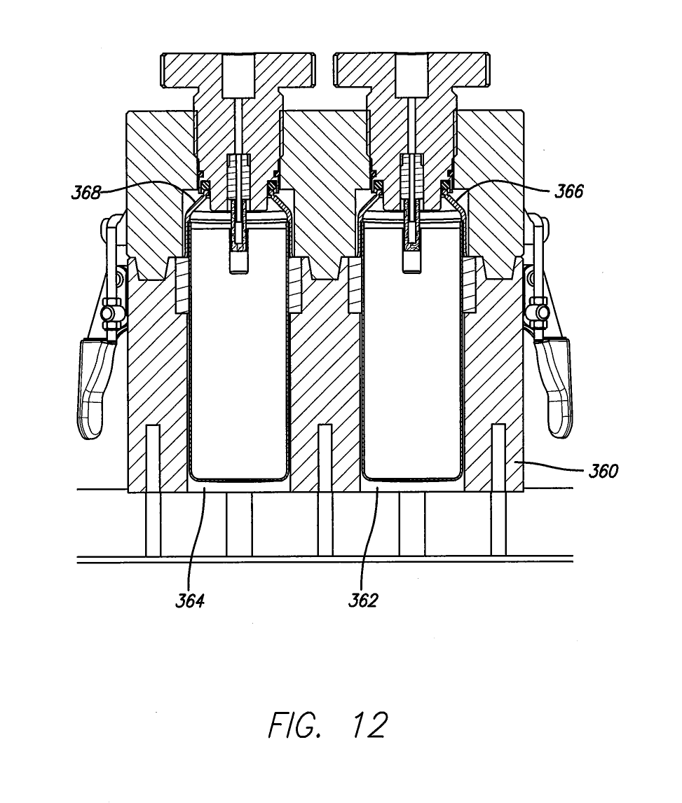

By reference to FIG. 12, there is illustrated an apparatus which permits the treatment of a plurality of HEU assemblies simultaneously. As is shown in FIG. 12, a bottom block (360) defines a pair of cavities (362) and (364) within which there is seated an HEU assembly (366) and (368) respectively. The HEU assemblies (366) and (368) are seated in such a way that the metal top section is seated against the steel support ring as above described and for the same purpose. The operation of the apparatus as shown in FIG. 12 is identical to that described above in conjunction with FIG. 11 except that more than one HEU can be treated at a time. It should be understood by those skilled in the art that an apparatus like that shown in FIG. 12 may include more than two cavities and may be modified regarding the manner in which the toggle clamps are secured depending upon the particular configuration of the apparatus and the number of HEU assemblies to be treated simultaneously.

By eliminating the air in the HEU through the apparatus as above described and replacing the air with C02, the cooling performance of the HEU is improved. The improved performance is attributable to the fact that air does not provide cooling while the C02 does. After the HEU is removed from the apparatus subsequent to the purging of the air particles with the C02 under pressure a protective cap as shown at 370 in FIG. 13 is applied to the top of the HEU to keep air form entering the HEU and displacing the residual C02 contained therein thereby retaining the residual head of approximately 10 grams of C02 on the carbon.

There has thus been disclosed an apparatus and process for replacing trapped air within the carbon particles contained within an HEU by carbon dioxide gas to thereby provide a residual head of carbon dioxide gas which may be retained within the HEU until such a time as the gassing cycle for a self-cooling container including an HEU is provided.

1. Apparatus for replacing air with carbon dioxide in a heat exchange unit containing compacted particles of activated charcoal as an adsorbent comprising:
A. a fixture defining at least one cavity adapted to receive said heat exchange unit;
B. a source of carbon dioxide gas under pressure coupled to said fixture and in communication with said heat exchange unit;
C. a valve for controlling application of said carbon dioxide gas from said source to said activated carbon particles;
D. a timer; and
E. means for detecting the application of the carbon dioxide gas under pressure to said carbon particles and activating said timer to maintain said pressure for a time sufficient to purge substantially all the air from said carbon particles and replace said air with carbon dioxide gas adsorbed on said carbon particles.

2. Apparatus as defined in claim 1 wherein said fixture includes a first block and a second block and means for sealingly securing said first and second blocks together.

3. Apparatus as defined in claim 2 wherein said fixture defines a plurality of cavities for receiving a plurality of HEU's simultaneously.

4. Apparatus as defined in claim 2 wherein said means for sealing includes a plurality of latches.

5. Apparatus as defined in claim 1 wherein said timer generates a signal at the end of said predetermined time to close said valve.

6. Apparatus as defined in claim 5 which further includes a cap adapted to be applied to said HEU when the carbon dioxide gas under pressure is no longer applied thereto to retain adsorbed carbon dioxide gas on said carbon particles.

7. A method for replacing air trapped in compacted carbon particles in a heat exchange unit (HEU) with carbon dioxide gas comprising:
A. providing a fixture for receiving said HEU;
B. placing said HEU within said fixture;
C. injecting carbon dioxide gas under pressure into said HEU; and
D. maintaining said carbon dioxide gas under pressure in said HEU for a time sufficient to purge said trapped air and replace it with said carbon dioxide gas adsorbed onto said carbon particles.

8. The method of claim 7 further including removing said carbon dioxide gas from said HEU and applying a cap to said HEU to retain said carbon dioxide gas within said HEU.

9. The method of claim 7 wherein the pressure of said carbon dioxide gas is maintained between approximately 10 to 50 Bars.
